(19) United States
(12) Patent Application Publication
(10) Pub. No.: US 2024/0386003 A1
(43) Pub. Date: Nov. 21, 2024

(54) SYSTEM AND METHODS FOR MITIGATING DATA DECAY

(71) Applicant: Super Truth, Inc., Wayne, PA (US)

(72) Inventors: Robert Paul Hill, IV, Wayne, PA (US); Jason Alan Snyder, Ridgewood, NJ (US); Jason Isla, Lyndhurst, OH (US); Elizabeth Young, West Chester, PA (US); Nicholas John Virag, Brooklyn, NY (US)

(73) Assignee: Super Truth, Inc., Wayne, PA (US)

(21) Appl. No.: 18/669,346

(22) Filed: May 20, 2024

Related U.S. Application Data
(60) Provisional application No. 63/467,588, filed on May 18, 2023.

(51) Int. Cl. G06F 16/215; G06F 16/23; G06F 21/62

(52) U.S. Cl. CPC G06F 16/215; G06F 16/2365; G06F 21/6245

(57) ABSTRACT

A system and method for verifying and grading information derived from a business's customer datasets is provided herein. The method includes the steps of receiving an initial data set, processing the initial data set, assessing the initial data set, and generating a report that outlines the initial assessment. The initial assessment may utilize first-party information and criteria to assess the initial data set according to a local source of truth. Following generating the report, additional data or features may be received and used to enhance the initial assessment.

### CLAIM OF PRIORITY

This application claims priority to U.S. Provisional Patent Application No. 63/467,588 filed May 18, 2023, the contents of which are incorporated herein by reference.

### FIELD OF PRESENT DISCLOSURE

The present disclosure is directed to a computer system, and process for preventing data decay. Specifically, the present disclosure is directed to a computing system and computer-implemented method for grading and managing datasets to safeguard a business from relying on obsolete datasets.

### INTRODUCTION

With the advent of the internet, businesses have had more access to data than ever before, and the utilization of data has become increasingly significant.

An important aspect of businesses utilizing data is the ability to manage its decay and gradual decline in quality over time to prevent lagging behind in an ever-evolving landscape. As data ages, its accuracy and relevancy steadily decrease, leading to inefficient business practices, which hampers a business's ability to quickly adapt to changing circumstances.

Managing obsolete data can be difficult and poses significant problems to businesses seeking to optimize their operations. Automating data quality checks with machine learning allows a business to quickly identify which datasets are obsolete and require updating. Ensuring high quality, up to date, data prevents businesses from making decisions on outdated information, ultimately leading to improved performance.

Ensuring data is up to date, or “healthy”, presents a variety of difficulties. Online business is inherently volatile, the information used to secure a competitive advantage can rapidly become obsolete, or “unhealthy”, making it increasingly important for businesses to screen and update data to ensure the information they are using to influence decisions is healthy. Unhealthy data can have detrimental effects on businesses; for example, a business relying on unhealthy data may increase their expenditures due to ineffective utilization of predictive analytics and/or trend analysis via AI algorithms. Moreover, managing and/or organizing data across various industries presents especially unique difficulties, which result from an influx of data spanning a plethora of data classifications. Therefore, proactive management of such large quantities of data to ensure said data's health, may be overly burdensome for an individual working at a business.

Accordingly, it would be desirable to provide systems and methods configured to keep datasets relevant and accurate by streamlining processes for assessing data. Yet further, it would be desirable to provide systems and methods disposed to managing and grading datasets to evaluate their health and ensure reliable and/or meaningful insights into customer behavior and/or market trends.

### SUMMARY

Disclosed herein are systems and methods for preventing data decay. More particularly, computing systems and computer implemented methods for assessing data quality and refining data to improve resulting information.

The method comprises receiving an initial data set, processing the initial data set, assessing the initial data set, and generating a report that outlines the initial assessment. In some embodiments, following the initial assessment, additional data may be utilized to enhance the initial assessment.

The initial data set may comprise first-party data. The first-party data is data supplied by the user and may, in some embodiments, be the user's own data to be analyzed. However, in another embodiment the initial data set may comprise public data or data received from a third-party to be analyzed. The initial data set may comprise a combination of any of the first-party data, public data, and data received from a third-party. Of course, the initial data set may be received from other means and the aforementioned are provided as non-limiting examples only.

Following receiving the initial data set, the data set may be processed. When processing the initial data set, the system may review the data as received to determine a weight of the data in the data set. The criteria for determining the weight of the data may be specific to the client's needs and/or desires. In some embodiments, the initial data set may comprise instructions regarding data relevance and how to weigh the data.

In one embodiment, the system may automatically assess the quality of the data. The quality of the data may, in some instances, be assessed according to the completeness and/or consistency of the data. For example, when the initial data set comprises a plurality of reports, the reports may be assessed to determine missing fields and/or information to determine whether the report is likely complete. Further, the reports may be assessed to identify outlying data. For example, a test result that does not align with the results generated in other reports and may be indicative of a testing or other error. It is contemplated that removing such information may improve the system by reducing the presence of bad and/or irrelevant data.

Further, in some embodiments, the weight of the data may be determined according to an age and/or health of the data. The trustworthiness of some data may degrade over time, as the data has likely changed. For example, information related to an individual's address, household income, and contact information may become less trustworthy as time passes, as these factors are likely to change over time. However, some data, such as lab results, age, or education level, may be unlikely to change and the age of the data may remain trustworthy over time. The exact criteria of what may determine trustworthiness may be specific to the client's use of the system and may be customized.

Following processing the initial data set, the data set may be assessed. Assessing the data set may be conducted against a source of truth. The user may define the parameters of the system, for example by providing data in the data set that is deemed to be truthful and information may be compared against. In one embodiment, the source of truth may comprise any of first-party, third-party, and public data. Of course, the source of truth may comprise information from other sources, and the aforementioned re provided as non-limiting examples only.

It is contemplated that the source of truth being defined by the user may customize the system and method according to the user's needs and/or desires. For example, the user may be able to limit the data to only those relevant to their purpose. This may reduce irrelevant data by customizing the system to only data the user has deemed as relevant, improving the analysis and insight of the data.

The data set may be compared to the source of truth to determine a ranking of the data. The ranking may be determined according to criteria received from the user. The criteria may be used to determine the relevance and/or trustworthiness of the data set against the source of truth. For example, data having a greater relevance and/or trustworthiness may be ranked higher than data having a low relevance and/or trustworthiness.

The criteria received from the user may be updated as needed so that an organization can view an assessment of their data based on certain data rankings, and an assessment of the same data based on separate data rankings. For example, zip code and age may be to some assessments while another assessment may be interested in how many records have a test result outside a normal range.

A report may be generated that comprises results of the assessment. The report may comprise the ranking of the data to present the findings of the system to the user.

In some embodiments, following generating the report the information presented in the report may be evaluated and altered. In one embodiment, the system may suggest additional data sets and/or parameters that may be utilized to enhance the results provided in the report. In an embodiment, the use of third-party data may enhance the existing data. For example, the third-party data may comprise information related to a population, household income, and consumer spending habits which may be utilized to provide additional context to the input data.

In one embodiment, the additional data sets and/or parameters may be assessed with the data according to the assessment conducted with the source of truth. In another embodiment, the additional data sets and/or parameters may be assessed independently of the source of truth assessment. The assessment may, in some embodiments, comprise correlating or otherwise comparing the input data to any of the source of truth or additional data sets and/or parameters.

It is an object of this disclosure to permit customized systems to analyze data and provide data insights.

It is a further object of the present disclosure to permit the customization of the source of truth used to analyze the data.

It is another object of the present disclosure to determine the weight of data received by the system.

It still another object of the present disclosure to provide a data enhancement system that may be utilized to refine data following an initial assessment.

It is an object of the present disclosure to prevent the decay of data during analysis by removing irrelevant data from analysis.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates a block diagram of a distributed computer system that can implement one or more aspects of the present disclosure.

FIG. 2 illustrates a block diagram of an electronic device that can implement one or more aspects of the present disclosure.

FIG. 3 illustrates a workflow according to one embodiment of the present disclosure.

FIG. 4 illustrates a block diagram of one embodiment of the system.

FIG. 5 illustrates a block diagram of one embodiment of the data processing module according to one or more aspects of the present disclosure.

FIG. 6 illustrates a block diagram of one embodiment of the machine learning module according to one or more aspects of the present disclosure.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

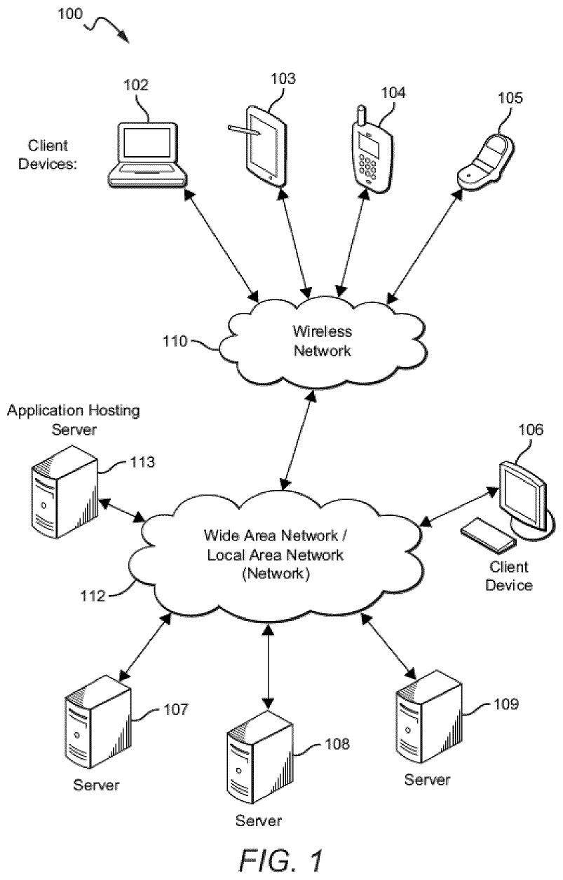

FIG. 1 illustrates components of one embodiment of an environment in which aspects of the present disclosure may be practiced. Not all of the components may be required to practice one or more aspects of the present disclosure, and variations in the arrangement and type of the components may be made without departing from the spirit or scope of the present disclosure. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. Various of the client devices 102-106 may include, for example, desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. I also illustrates application hosting server 113.

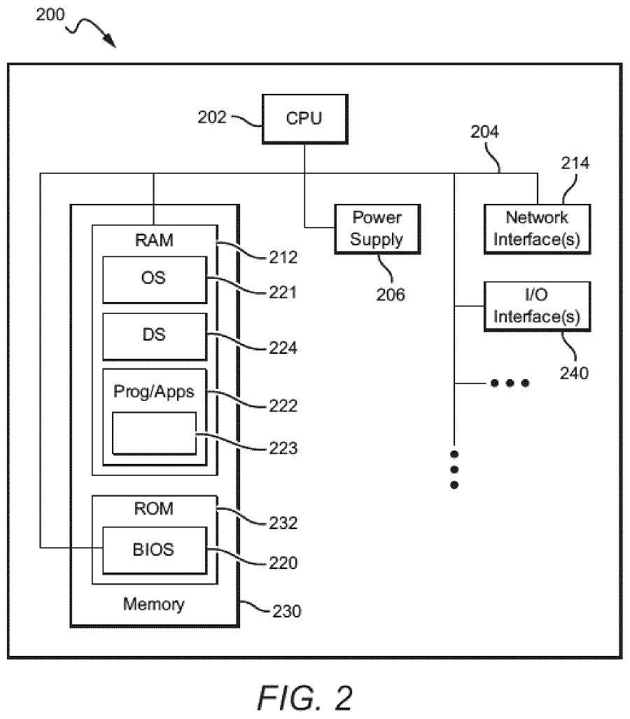

FIG. 2 illustrates a block diagram of an electronic device 200 that can implement one or more aspects of an apparatus, system and method for validating and correcting user information (the “Engine”) according to one embodiment of the present disclosure. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the present disclosure. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can case processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as IOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present disclosure include apparatuses, systems, and methods implementing the Engine. Embodiments of the present disclosure may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

In an embodiment, the system may receive, process, generate and/or store time series data. The system may, in some embodiments, include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data. In another embodiment, the system may comprise a secure file transfer protocol (SFTP) connection. The SFTP connection may permit a secure transfer of sensitive files and other communications between networks. The files and communications may be encrypted prior to communication. In an embodiment, the system may require user authentication to permit accessing and providing any files.

The present disclosure relates to systems and methods for verifying and grading information derived from a user's datasets. The terms user, client, and business may be used interchangeably and refer to one another.

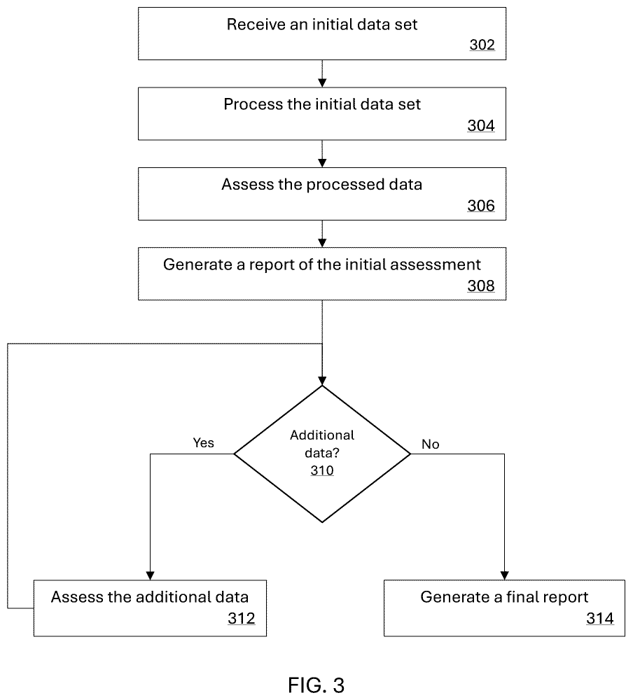

FIG. 3 illustrates a flowchart describing one embodiment of a workflow for verifying and grading information derived from the user's dataset. In step 302, an initial data set may be received from the user. The initial data set may comprise first-party data, or other data to be analyzed, by the system. The initial data set may comprise any information that the user may desire to be analyzed, for example studies, reports, lists, or other information.

Following receiving the initial data set in step 302, the initial data set may be processed 304. In an embodiment of the present disclosure, a data mapper may be created when the system receives the initial data set on a user interface, such as the Customer-Facing App. In an embodiment, the Customer Facing App may extract data points from the initial data set. For example, the Customer Facing App may read columns from the user-supplied list, which may allow for users to map each column to a data point. A user-supplied column and its relationship with a final column, may be stored in a database. In one embodiment, if future users perform the same task as previous users, a mapper_archive table may be queried to find matching columns from the previous user's list. If a match is found, the fields that the previous user chose may be returned. However, in another embodiment, the processing may be performed in any suitable manner.

In some embodiments, the system may grade and/or enrich their data via a Data Enrichment Handler. The request may be automatically invoked or may be received as a request from the user. Logic may be implemented to parse a data file, and an event with a batch of messages may be posted to a distributed message queuing service (i.e., Amazon SQS) for processing. For example, with CSV data files, the batch may be a set of rows from the data set. An event-driven, serverless computing platform (i.e., AWS Lambda) may listen for new events and may handle new requests.

The rows may be passed through the Data Enrichment Handler, which may pass the data through a data processing workflow. If one row of the batch fails, the failed row may be rerun. A grade for the data may not be given unless there has been a data enrichment request.

After each data enrichment request, a universally unique identifier (“UUID”) may be created and said UUID may be passed along to each future step. The original values may be passed along for comparison and grading at the end of the enrichment session. An enriched list may begin with empty values and/or may be configured to fill all columns from an empty set. If a data point cannot be found, a detractor for that row may be created. All rows of the user-supplied list can be iterated over to check for a main URL. If a row's URL field is empty, the Scrape Search Result Page (SERP) may be run.

If no main URL is supplied, then a URL-encoded Google search query may be constructed by utilizing a scraper which may be behind a web-scraping tool (i.e., ScraperAPI) proxy configured to prevent the scraper's Internet Protocol address from being blocked. A source code may be returned from Search Engine Results Pages (“SERP”), and a check may be performed to detect the presence of a Google My Business (“GMB”) listing (or other suitable listing from a management or optimization business profile platform) for a match. If the GMB listing is a match, data, which may include a company's name, phone number, address, and/or URL, may be extracted. Further, if said data has been extracted, the data may be stored as authoritative data points, which may not require further verification. If there is not a GMB listing match, a check of the top ten SERP results may be performed, wherein the authority of the results can be verified.

An Authoritative URL Validator may be run on each of the top ten results. The content of each URL may be scraped using a scraper behind the web-scraping tool proxy, which may perform a data check. The data may include a company's name, phone number, and/or address. A regular expression may be run over areas, which may include title tag, meta title and description, and domain name, to verify the authority of the SERP results. If the data cannot be verified, a regex may be run to find matches for the user-supplied data points. A ranking system of the URL's can be created, with verified URL's ranking higher than unverified URL's. If no matches are found, a Secondary Source Parser may be run.

In an embodiment, an Information Extraction (IE) process may be performed. In one embodiment, to read a URL and infer a company name, a candidate may need to be found, and said candidate may be in the form of a named entity which may be labeled “COMPANY_NAME.” Once the named entity has been found from a home page of a company website, the named entity may be transformed into a lowercase format.

The domain name may be checked against substring occurrences of the first word of the named entity. If the first word exists within the domain name, an authoritative name of said named entity may be determined. Separate from the Natural Language Processing (NLP) phase of the Main URL Supplied step, an isolated Named Entity Recognition (NER) pipeline may be run on a Title Tag, Meta Title, and Meta Description. A reference to text snippets from the Title Tag, Meta Title, and Meta Description may be stored in a variable for future processing. Specific entities may be searched for within content that is retained.

CSS Classnames, Image Filenames, and Anchor Tags may be run separate from the main NLP phase on the isolated NER pipeline. An HTML document can be searched to find predefined CSS Classnames and/or Image Filenames, which may signal the existence of content that does not normally have textual labels. As a non-limiting example, a phone number may be separated from a fax number. A web page may have two numbers without a textual label, and both numbers may be extracted. Once the numbers have been extracted, the CSS Classnames and/or Image Filenames can be used to pinpoint probable regions a phone number is likely to appear in. Moreover, a search for the word “fax” can be performed, and if there are corresponding HTML elements with the same Classnames, then a search within the HTML element may be performed to find a corresponding number. However, if there are no Classnames available, a search for Image Filenames such as “phone,” “number,” “fax,” and “office,” may be performed.

While the aforementioned embodiment describes one method for processing the initial data set, other methods may be utilized. For example, in other embodiments, the processing may extract information PDFs, word documents, figure, or other file types. The processing may comprise identifying and data features. In some embodiments, the data features may be extracted and may be transformed into a consistent format. In further embodiments, the data features may be classified into various categories according to the type of data. The initial data may, in some embodiments, be processed to determine a completeness of the data. For example, the initial data may be processed to determine whether there are any missing data fields. Further, the initial data may be processed to determine a consistency between the initial data. In some embodiments, if data is inconsistent it may be separated or otherwise removed from the data set. In an embodiment, the consistency of the data may be determined through comparison to defined parameters and/or a source of truth, discussed in more details herein.

In one embodiment, an Extract, Transform, Load (ETL) pipeline may be utilized to process the data set at step 304. In the ETL pipeline, raw data may be extracted from the initial dataset and may be transformed. Transforming the data may comprise cleaning, filtering, aggregating, joining, or otherwise transforming the raw data into a consistent format. The format may be determined according to the client's specification and/or according to the industry standard. Following transforming the data, the data may be loaded into an analysis database for assessing the data, discussed in more detail under step 306.

Any of the steps described in the aforementioned embodiments may be utilized in conjunction with one another. Further, any of the steps of processing the data set 304 may be combined with or performed in conjunction with assessing the data 306.

Assessing the data 306 may comprise comparing the data processed in step 304 with a source of truth. The source of truth may be defined by the user. In one embodiment, the source of truth may be a user-specific source of truth that is stored in the user account and may be accessible for multiple uses of the system. In some embodiments, the source of truth may be defined for the initial data set. For example, if the initial data set comprises information and/or may be utilized for a purpose outside of the parameters of a saved source of truth. The source of truth may, in some embodiments, be saved to the user account and may be utilized in future interactions with the system.

The source of truth may comprise a database that the user has defined as the baseline to compare the initial data to. It is contemplated that the source of truth may be customizable for each user, to permit the system to be tailored to the user's specific needs. This may result in analysis and reports to streamline results and reduce irrelevant and inaccurate data. The source of truth may, in some embodiments, comprise first-party information, for example studies and reports generated by the client. In some embodiments, the source of truth may comprise third-party, global, and/or industry data. For example, the source of truth may comprise census data, ESRI data, social media data, or other data. Of course, the source of truth may utilize both first-party and third-party, global, and/or industry data.

The source of truth may be altered or otherwise adjusted as may be desired. For example, the user may provide new data or instructions to the source of truth or may remove data or change instructions for the source of truth.

In some instances, any of the data in the processed data set may not be comparable to the source of truth database. This may occur for a variety of reasons and should not be limited to specific instances. In such an instance, the system may assign a weight to the data absent the source of truth database. In some embodiments, a score may be assigned according to a trustworthiness of the data. For example, as data ages it may become less trustworthy and may be given less weight than other data in the system.

The point in which the system may classify data as less trustworthy may be determined according to criteria provided by the client. For some data the trustworthiness of the data may degrade over time, such as a person's home address and/or contact information. As time passes, the likelihood that this information has changed may increase and the data may be considered less trustworthy, and thus, may be less relevant for the analysis. However, other data, such as laboratory results or a person's date of birth, may not change over time and thus may be considered trustworthy even after a substantial length of time has passed. Depending on the data and purpose being examined by the system, the trustworthiness may be adjusted.

As a result of the rate at which data evolves in the modern landscape, data's health may diminish over time as a consequence of changes in environmental factors. Moreover, when data becomes unhealthy it may become inaccurate, and entities utilizing said unhealthy data may be at a disadvantage in the marketplace. Said disadvantages may include decreases in the reliability of information used in a decision-making process and/or the usefulness of said information's insights.

In an embodiment, a company may be able to identify when a dataset has become unhealthy by analyzing the dataset's grade, discussed herein. Likewise, if said company recognizes that the dataset's grade is low, the company may leverage autonomous data quality checks and/or machine learning algorithms to compare historical records against current records. Said autonomous data quality checks and/or machine learning algorithms may allow a company to quickly identify when a dataset requires updating. Further, a company may update a dataset by auditing and/or cleansing said dataset throughout regular intervals, which in turn, may prevent decisions, based upon unhealthy data, from being made. Such regular auditing and/or cleansing of datasets may provide a company with a competitive advantage due to the exploitation of healthy data, which may ensure that a company's models continue to provide reliable insights into customer behavior and/or market trends. Said insights may allow for a company to ensure generative AI models continue to operate at optimal conditions.

Thus, the system may be customized such that even in the absence of comparative data, an appropriate weight may be assigned to the data for analysis purposes. This permits the data to be analyzed by the system, without skewing the resulting information. For example, ignoring data may result in accurate analysis that fails to consider all factors, while including the data without processing may prevent appropriate comparison between the data in the system.

In some embodiments, the system may sort or otherwise rank and/or grad the data. Ranking and/or grading the data may provide analysis between the initial data and the source of truth. For example, a higher ranking and grade may be determined when the data has a higher correlation to the source of truth. Thus, when data is closer to the source of truth, it is more likely to be accurate.

In an embodiment, a grade may be generated by processing one classification of data at a time. For example, one row at a time and the IE process may hold reference to the row's index, as well as the row's original value. As authoritative values are found, the reference to the entity may be stored. As a non-limiting example, if a phone number is found from the GMB listing, the phone number may be stored as an authoritative phone number. The authoritative values may be compared to the original corresponding value, and if the original value does not match the authoritative value, a score of 0 for that field may be given. Once each column has received a score of 0 and/or 1, the average score of all columns may be calculated, and the average score of the columns may be the final score for the column. When each column receives a score, the average score among all columns may be calculated, which may generate a final score for the list. Of course, the grade may be determined in any manner that may be desired, and the aforementioned is provided as a non-limiting example only.

In some embodiments, machine learning may be utilized to conduct any of the analysis steps. For example, Generative AI may be exploited by a business and said Generative Al may accelerate the rate at which complex problems are solved. Further, Generative Al may analyze and learn from data, which in turn, may provide insights and/or generate new data. Such Generative Al may utilize algorithms and/or deep learning technologies as a means for understanding a dataset, such as the initial data and/or the source of truth. Said algorithms and/or deep learning technologies may generate novel outputs, as such, Generative Al may have a multitude of applications.

The applications of Generative AI may include the creation of artistic works and/or improving medical research efforts. As a nonlimiting example, a business may utilize Generative Al to increase the efficiency of product design processes and/or developmental processes. Moreover, allowing a machine to evaluate a design may expedite the generation of ideas based on a business's desired outcomes.

In an embodiment, Generative AI driven models may help a business optimize marketing campaigns by suggesting changes that may produce better results and/or aid a business's customer services by providing an automated response, which may be tailored to a customer's needs and/or preferences. Generative AI may improve data-driven decision making for a business, which may be achieved by accessing data generated by machine learning algorithms. Such a machine learning algorithm may improve the methods used to provide insight into a customer's behavior, which may allow a business to target the customer more effectively and/or develop products and/or services that may enable the business to maximize a profit.

There may be several benefits to a business utilizing Generative AI. Such benefits may include automation of mundane tasks, increasing efficiency, productivity, and/or accuracy of certain processes, generate personalized customer experiences, and/or optimize workflow processes. Said utilization of Generative Al may save a business money by reducing manual labor expenditures and/or reducing the investment in costly data processing tools. Furthermore, the exploitation of Generative Al may provide a competitive advantage by improving the rates at which innovation occurs and/or providing insight regarding industry trends.

The systems and methods, as described herein, may utilize live data. Such utilization of live data may allow for a company to maximize their sales velocity. Moreover, the daily manual efforts of employees (i.e., sales development representatives or “SDR”) for a company may be reduced, which may allow for said employee to spend more time in front of qualified prospects. Said increase in time spent with qualified prospects may result in an increase of a company's sales. Furthermore, utilizing live data may provide self-enriching feedback loops that may furnish daily sales insights, and may prevent reliance on a third-party data source. In another example, the use of live data may be utilized to process lab data as it is received by the system. This may permit a rapid analysis of the results of the lab data and may improve diagnostic capabilities. Indeed, in some embodiments, the source of truth may comprise demographic and/or FDA information that may be utilized to determine a treatment for the patient. In other embodiments, the system may identify trends and may suggest further testing and/or treatment. Of course, the system may be utilized with any number of uses.

An example workflow according to one or more aspects of the present disclosure is provided herein as an illustrative example. A company may receive an Ideal Customer Profile (ICP) from a client. The ICP may be used to source potential fit companies from a multitude of sources, wherein the company may manually research the fit companies to confirm fit and/or a targeting strategy. Moreover, a live spreadsheet creator (i.e., Clay) may be used to scrape, categorize, and/or enrich a domain for targeting information. Said information may be tested for accuracy using an accuracy test. In such an accuracy test, if the targeting information is greater than eighty-five percent accurate the scraped information may be exported as a means for determining a model fit percentage. If the targeting information is less than eighty-five percent accurate, a business-to-business predictive analytics tool (i.e., obviously.ai) may be used to tune the targeting information until it exceeds eighty-five percent accurate. Once the scraped information has been exported, a company's team may check a confidence interval and/or unscrapeable sites. Further, the company's team may enrich contact records, and may upload a file (i.e., csv) into a client Customer Relationship Management software (CRM) (i.e., Salesforce).

In a further embodiment, the systems and methods, as described herein, may allow for a company to stay ahead of market changes and/or environmental factors that may cause datasets to become unhealthy. To stay ahead of market changes and/or environmental factors leading to unhealthy datasets, said systems and methods may begin by versioning said dataset. Once a dataset has been versioned, the dataset may be audited to determine the health of the data comprising the dataset. After the data has been audited, said data may undergo a validation process, wherein the existing data may be continuously refreshed. Said continuous data refreshing may allow a company to quickly identify ageing or unhealthy data which may improve the functionality of generative AI and/or may ensure a company bases decisions on reliable data, which may prevent erroneous conclusions resultant from unhealthy data. As a non-limiting example, a user may purchase a list of data from a website (i.e., Zoominfo) based upon an approved ICP. Said list of data may be converted to a CSV file which may be imported into a Customer Facing App (also referred to herein simply as the “app”).

Once the data list has been imported into the app, said app may produce a grade based upon the data's health. Said graded data list may be enhanced by improving the data's health, which in turn, may ameliorate said data's accuracy. In a further embodiment, the data list, after having its' health improved, may be enriched with industry-specific data by the systems and methods as described herein. Such enrichment may allow a company to build more specific and/or improved ICPs. The improved ICPs may be sent to a CRM (i.e., Salesforce) and/or a proprietary CRM.

In an alternative embodiment, after the improved ICP has been created, a complete list may be viewed, wherein said complete list may be sorted and/or filtered within a user interface. As a non-limiting example, a user may view the completed list and save any set of used filters, wherein the filters may be visible to other members of a team. Further, the complete list may allow for development of a more specific ICP, wherein the more specific ICPs may be derived from an enrichment of the data comprising the complete list. Moreover, the specific ICPs may be synced with a CRM (i.e., Salesforce), wherein the synchronization may allow for a two-way read and/or write cadence. The specified ICP may also be exported to a proprietary CRM, which may allow for the specified ICP to be downloaded as a file (i.e., csv) to a user's electronic device. As a non-limiting example, a list of contacts may be purchased from a source, wherein the list of contacts may be cleansed and/or enriched by the systems and methods as described herein.

Returning the FIG. 3, following assessing the processed data 304, a report comprising an initial assessment may be generated 306. The initial assessment may comprise the results of step 304. For example, the initial assessment may comprise a ranking and/or grade for the data. Further, in some embodiments, the report may comprise a visualization of the data, for example, a graph, table, chart, infographic, or other visualization.

Following generating the report, additional data may be received by the system, as illustrated in step 310. In some embodiments, the user may be prompted to enter additional data following review of the initial assessment. The additional data may be provided to enhance the initial assessment, by providing additional data and/or criteria for assessment in step 312.

In one embodiment, the additional data may be third-party data that may be correlated to the assessed data. For example, when the initial data and/or the source of truth comprises first-party data, third-party data may be utilized to provide additional context to the assessed data. The third-party data may be correlated or otherwise compared to the initial data and/or the source of truth to enhance the data.

In an embodiment, the third-party data may comprise at least one category and any of the at least one categories may be correlated to the data. For example, the third-party data may comprise information in categories such as population, household income, and consumer spending habits, among others. Any of these categories may be layered to provide additional analysis of the data.

It is contemplated that correlating third-party data to the analyzed data may improve understanding and/or interpretation of data.

The system may receive any additional data 310 that may be needed or desired. In some embodiment, the system may generate an intermediary report following assessing the additional data 312 and generating the final report 314. This may permit the user to interrogate and otherwise interact with the data to enhance the data in the report. Through this interaction, the data in the report may be specific to the client, such that even if two clients were to provide the same input, the resulting output may be unique to the specific client. It is contemplated that this may improve data processing and analysis for individualized needs. In some embodiments, the system may be trained according to the client.

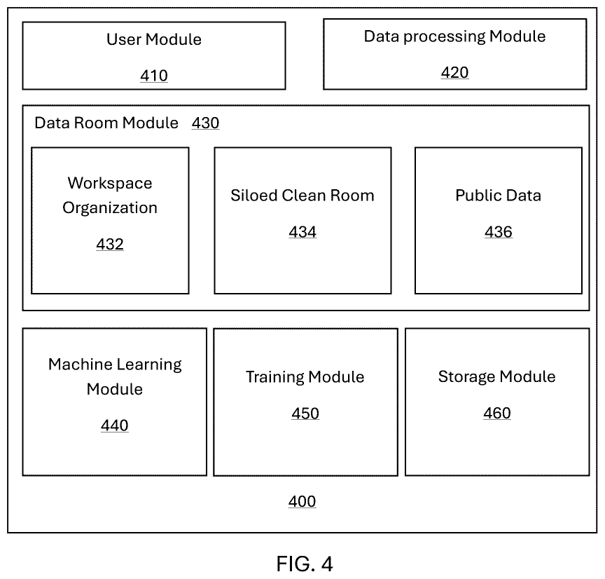

A diagram illustrating one embodiment of the system 400 is illustrated in FIG. 4. The system may comprise a user module 410 configured to interact with the user. The user module 410 may be a user interface and may be utilized to authenticate the user. For example, by authenticating a user account. The user account may, in some embodiments, be associated with a client and/or business. In order for the system to be accessed, the user must first be authenticated. The user may be authenticated according to any means of authenticating the user, such as a username, password, and, in some embodiments, multi-factor authentication.

Upon authenticating the user, a system specific to the user may be loaded. This may load any of the first-party data, sources of truth, reports, or other information associated with the client. Further, the user may be able to upload data to the system.

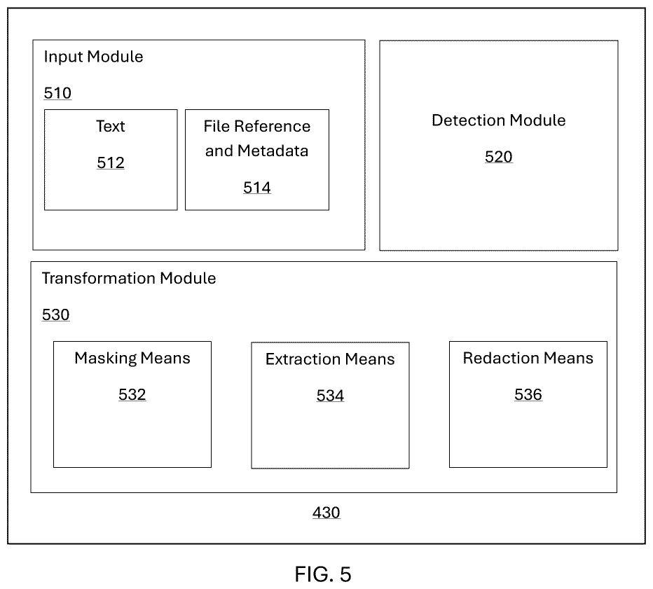

The uploaded data may be run through the data processing module 420. The data processing module 420 may be configured to perform the data processing step 304 described in FIG. 3. An embodiment of a data processing module 420 is illustrated in FIG. 5. The data processing module 420 may comprise an input module 510, a detection module 520, and a transformation module 530. The input module 510 may receive the data from the user. This data may be raw data and may comprise text 512 and/or file reference and metadata 514. The file reference and metadata 514 may comprise image, audio, and/or video data. The detection module 520 may detect the presence of data in the system. For example, the detection module 520 may detect the presence of text, graphs, or other data in the system to be analyzed.

Following the detection module 520 the data may enter the transformation module 530 to cleanse the data. Cleaning the data may be based on each organization's preference. For example, the data may be cleansed to standardize all US postal codes to 5 digits instead of 9 or standardize the decimal places and unit of measurement for specific lab tests. In some embodiments, the detection module may flag suspicious values for manual correction or removal. One improvement offered by the detection module 520 comprise correcting suspicious records, which can greatly skew reporting around average values or common incidence. This is also true of de-duplicating records and normalizing similar terminology (e.g. lab test names).

In some embodiments, the data may be quarantined in a quarantine module prior to entering the transformation module 530. The transformation module 530 may receive the data and may pass the data through any of a masking means 532, extraction means 534, and redaction means 536. The masking means 532 may create remove confidential information from the data. For example, the masking means may identify and remove confidential information, such as protected health information (PHI) and/or personally identifiable identifying information (PII). This may be accomplished according to any method of masking, for example by replacing the confidential information with a null value. It is contemplated that this may prevent clients to examine and interrogate data without exposing PHI and/or PII.

The redaction means 536 may, in some embodiments, work in conjunction with the masking means to remove confidential information. In a further embodiment, the redaction means 536 may redact data that is not necessary for assessment. For example, the name of an organization who collected the data, a cost of the data, or other data not necessary for assessment.

The extraction means may be any means suitable for extracting the features as discussed herein. For example, using ETL or other extraction means to determine features to be used for analysis.

Following the data processing module 420, the cleansed data may enter the data room module 430. The data room module 430 may comprise a workspace organization module 432, a siloed clean room 434, and a public data module 436. The public data module 436 may comprise third-party data. In some embodiments, the public data module 436 may be in communication with third party data stored on another device and/or network. The siloed clean room 434 may be an isolated environment where data may be combined and analyzed. It is contemplated that the siloed clean room 434 may be combined and analyzed without compromising the privacy or security of the cleansed data. The organization module 432 may comprise the cleansed data from the first-party, previous user data including sources of truth or previously generated reports, and analysis criteria and/or instructions.

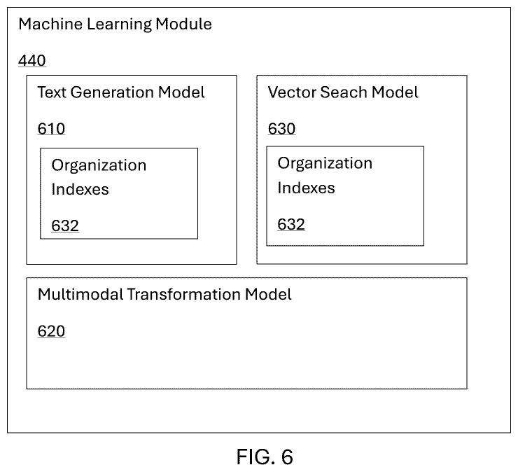

The system 400 may further comprise a machine learning module 440. One embodiment of the machine learning module 440 is illustrated in FIG. 6. The machine learning module 440 may comprise a text generation model 610, a multimodal transformation model 620, and a vector search model 630.

The text generation model 610 may be utilized to promote interaction with the user. For example, the text generation model 610 may comprise a chatbot or other interface that may receive and facilitate interactions with the user. This may be used to receive additional information and interrogate the processed data. In an embodiment, the text generation model 610 may utilize machine learning algorithms, such as GPT-4, to provide human-like text-based interactions. In one embodiment, the text generation model 610 may comprise a retrieval model interface. The retrieval model interface may be utilized to assess the data. In one embodiment, the retrieval model interface may be utilized to rank the data. The process for ranking the data may be performed as discussed in any method in the current disclosure. For example, the retrieval model interface may identify similarity between data and may rank the data to determine data relevant to a query. In an embodiment, the retrieval model interface may be utilized for structure data to construct queries that may delivered to the user. For example, the retrieval model interface may utilize a LangChain SQL agent or other interface to conduct the interaction with the user.

The multimodal transformation model 620 may keep the system 400 updated as more data becomes available. The multimodal transformation model 620 may, in some embodiments, provide an output embedding of the input received in the input module 510. The input may, in an embodiment, be embedded into a vector. Of course, the data may be embedded into other analysis means.

The vector search model 630 may create organization indexes 632 of the embedded vectors created by the multimodal transformation model 620. The creation of the organization indexes 632 may permit fast retrieval of data. This may reduce processing time in the system and may allow the data to be compare more efficiently. Each vector may be associated with a specific set of data, for example a lab report, and may comprise shared and/or similar data in the same position. This may permit comparison of data according to the positioning in the vector.

Further the system 400 may comprise a storage model 460. The storage model 460 may be any storage means, such as those described in FIG. 2. The storage model 400 may comprise any of the data received by the input module 510. Further, in some embodiments, the storage model 400 may comprise at least one trained model and/or at least one trained dataset. The trained models and/or datasets may be utilized to analyze the data. The trained models and/or datasets may be existing models and/or datasets or may be models and/or datasets that have been previously trained by the system. In some embodiments, the trained models and/or datasets may be utilized with the training module 450. The training module 450 may fine-tune the trained models and/or datasets. The training module 450 may permit adjustments being made to the datasets and/or models to customize the training module 450 to the user's purpose. This may allow the data set to be tailored to its performance with a target task, improving the performance of the model and/or dataset with the algorithm. Thus, improving the assessment of data and permitting its use for custom purposes.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only.

1. A computer-implemented method of verifying and grading first-party information, the method comprising:
receiving an initial data set from a user, wherein the initial data set comprises first-party information;
processing the initial data set to determine a weight of the first-party data;
assessing the initial data set against a source of truth, wherein the source of truth is a user defined database that serves as a baseline for data comparison;
generating a report that outlines an initial assessment of the initial data set;
receiving additional data;
in response to receiving the additional data, assessing the additional data against the initial data set and the source of truth; and
generating a report that outlines a relationship between the initial assessment and the additional data.

2. The method of claim 1, wherein the additional data is received in response to the initial assessment of the data to interrogate the initial assessment.

3. The method of claim 2, wherein interrogating the data enhances the data by utilizing third-party data.

4. The method of claim 1, wherein assessing the data is performed using pre-existing training algorithms that are fine-tuned according to the data set.

5. The method of claim 1, wherein when data in the initial data set cannot be assessed against the source of truth, the data may be assessed to determine its trustworthiness.

6. The method of claim 1, wherein assessing the initial data set comprises masking confidential information from the initial data set to remove protected health information (PHI) and personally identifiable identifying information (PII).

7. A system, comprising at least one processor, at least one database, at least one memory comprising computer-executable instructions which, when executed by the at least one processor, cause the processor to:
receive an initial data set from a user, wherein the initial data set comprises first-party information;
process the initial data set to determine a weight of the first-party data;
assess the initial data set against a source of truth, wherein the source of truth is a user defined database that serves as a baseline for data comparison;
generate a report that outlines an initial assessment of the initial data set;
receive additional data;
in response to receiving the additional data, assess the additional data against the initial data set and the source of truth; and
generate a report that outlines a relationship between the initial assessment and the additional data.

8. The system of claim 7, wherein the additional data is received in response to the initial assessment of the data to interrogate the initial assessment.

9. The system of claim 8, wherein interrogating the data enhances the data by utilizing third-party data.

10. The system of claim 7, wherein assessing the data is performed using pre-existing training algorithms that are fine-tuned according to the data set.

11. The system of claim 7, wherein when data in the initial data set cannot be assessed against the source of truth, the data may be assessed to determine its trustworthiness.

12. The system of claim 7, wherein assessing the initial data set comprises masking confidential information from the initial data set to remove protected health information (PHI) and personally identifiable identifying information (PII).

13. A non-transitory computer readable medium having a set of instructions stored thereon that, when executed by a processing device, cause the processing device to carry out an operation, the operation comprising the steps of:
receiving an initial data set from a user, wherein the initial data set comprises first-party information;
processing the initial data set to determine a weight of the first-party data;
assessing the initial data set against a source of truth, wherein the source of truth is a user defined database that serves as a baseline for data comparison;
generating a report that outlines an initial assessment of the initial data set;
receiving additional data;
in response to receiving the additional data, assessing the additional data against the initial data set and the source of truth; and
generating a report that outlines a relationship between the initial assessment and the additional data.

14. The non-transitory computer readable medium of claim 13, wherein the additional data is received in response to the initial assessment of the data to interrogate the initial assessment.

15. The non-transitory computer readable medium of claim 14, wherein interrogating the data enhances the data by utilizing third-party data.

16. The non-transitory computer readable medium of claim 13, wherein assessing the data is performed using pre-existing training algorithms that are fine-tuned according to the data set.

17. The non-transitory computer readable medium of claim 13, wherein when data in the initial data set cannot be assessed against the source of truth, the data may be assessed to determine its trustworthiness.

18. The non-transitory computer readable medium of claim 13, wherein assessing the initial data set comprises masking confidential information from the initial data set to remove protected health information (PHI) and personally identifiable identifying information (PII).
